(19) United States
(12) Patent Application Publication
(10) Pub. No.: US 2003/0123893 A1
(43) Pub. Date: Jul. 3, 2003

(54) Image forming apparatus

(76) Inventors: Masahiko Fukano, Osaka (JP); Kunihiko Ishii, Osaka (JP); Yasuhiro Michishita, Osaka (JP)

Correspondence Address: SMITH, GAMBRELL & RUSSELL, LLP, 1850 M STREET, N.W., SUITE 800, WASHINGTON, DC, 20036, US

(21) Appl. No.: 10/327,065

(22) Filed: Dec. 24, 2002

(30) Foreign Application Priority Data
Dec. 28, 2001 (JP) 2001 - 398945

(51) Int. Cl. G03G 15/20

(52) U.S. Cl. 399/69; 399/70

(57) ABSTRACT

An image forming apparatus which passes a sheet bearing a toner image between a heat roller and a pressure roller constituting a fixing device to fix the toner image onto the sheet. The image forming apparatus comprises thermistors and a controller. The controller starts heating of the heat roller while stopping the heat roller and the pressure roller, then starts rotations of both rollers when the surface temperature of the heat roller, as detected by the thermistor, reaches a set value which is lower than a fixing standby temperature, and permits the use of the fixing device when the surface temperature of the pressure roller, as detected by the thermistor, reaches a predetermined value.

### FIELD OF THE INVENTION

This invention relates to an image forming apparatus in which a sheet bearing a toner image is passed between a heat roller and a pressure roller constituting a fixing device to fix the toner image onto the sheet. More specifically, the invention relates to an image forming apparatus, such as a laser printer or a facsimile, which enables the fixing device to be used in a low temperature atmosphere in a shorter warm-up time than before, without impairing the desired fixing effect.

### DESCRIPTION OF THE PRIOR ART

An image forming apparatus, for example, an electrostatic copier, is generally mounted with a fixing device having a heat roller incorporating a heater, and a pressure roller rotating in pressurized contact with the heat roller. In this type of fixing device, called a thermal fixing device, after the power is turned on in order to start the copier, the heater is energized to start heating of the heat roller. The heat roller and the pressure roller in pressurized contact with each other are maintained at a standstill. When the surface temperature of the heat roller reaches a predetermined set temperature after heating of the heat roller is started, the heat roller and the pressure roller both start to be rotated (so-called aging is performed). The rotations of the heat roller and the pressure roller are continued until the surface temperature of the heat roller reaches a fixing standby temperature, whereby a warm-up of the fixing device is carried out. Such an image forming apparatus is disclosed, for example, in Japanese Unexamined Patent Publication No. 1981-142563.

In the above-described conventional image forming apparatus, the aging for rotating both the heat roller and the pressure roller after start of heating of the heat roller is performed for the purpose of raising the surface temperature of the pressure roller uniformly. This is intended to perform fixing at the initial stage of the use of the copier in a satisfactory manner, thereby eliminating fixing failures. The above aging is effective for uniformizing the surface temperature of the pressure roller. However, since the heat roller and the pressure roller are both rotated, the amount of heat lost from the heat roller to the pressure roller is much larger than when both rollers are at a standstill. As a result, a considerably long time is taken until the surface temperature of the heat roller rises to the fixing standby temperature. Hence, a total warm-up time for the fixing device is markedly prolonged in the above-mentioned copier in which the power is turned on when starting the machine, then heating of the heat roller in the fixing device is started; after the surface temperature of the heat roller reaches a predetermined set temperature, aging is carried out for a certain time; and the aging is continued until the surface temperature of the heat roller rises to the fixing standby temperature. Such a tendency is, needless to say, noticeable particularly in a low temperature atmosphere rather than in an ordinary temperature atmosphere. Consequently, the standby time from the time when the power to the copier is turned on until the time when the fixing device becomes usable, namely, the standby time from the time when the power to the copier is turned on until the time when copying can be started, particularly lengthens in a low temperature atmosphere. To achieve, fully reliably, the effect of raising the surface temperature of the pressure roller uniformly, thereby satisfactorily performing fixing in the initial stage of use of the copier and eliminating fixing failures, it is a prerequisite that sufficient allowance be provided in the warm-up time and an ample time be taken for aging. Recently, however, with the overall speeding of operation of image forming apparatuses, including copiers, a reduction in the warm-up time has been demanded more strictly than before, and a demand has been expressed for improvements in the low temperature atmosphere.

### SUMMARY OF THE INVENTION

An object of the present invention is to provide a novel image forming apparatus which enables a fixing device to be used in a low temperature atmosphere in a shorter warm-up time than before, without impairing the desired fixing effect.

Other objects and features of the present invention will become apparent from detailed descriptions of embodiments of an image forming apparatus according to the present invention with reference to the accompanying drawings.

According to an aspect of the invention, there is provided an image forming apparatus which passes a sheet bearing a toner image between a heat roller and a pressure roller constituting a fixing device to fix the toner image onto the sheet, comprising

heat roller surface temperature detection means, pressure roller surface temperature detection means, and a controller for controlling the fixing device, and wherein

the controller controls the fixing device so as to start heating of the heat roller while stopping the heat roller and the pressure roller, then start rotations of both the heat roller and the pressure roller when the surface temperature of the heat roller, as detected by the heat roller surface temperature detection means, reaches a set value which is lower than a fixing standby temperature, and permit the use of the fixing device when the surface temperature of the pressure roller, as detected by the pressure roller surface temperature detection means, reaches a predetermined value.

According to another aspect of the invention, there is provided an image forming apparatus which passes a sheet bearing a toner image between a heat roller and a pressure roller constituting a fixing device to fix the toner image onto the sheet, comprising

heat roller surface temperature detection means, pressure roller surface temperature detection means, and a controller for controlling the fixing device, and wherein

the controller controls the fixing device so as to start heating of the heat roller while stopping the heat roller and the pressure roller, then start rotations of both the heat roller and the pressure roller when the surface temperature of the heat roller, as detected by the heat roller surface temperature detection means, reaches a set value which is lower than a fixing standby temperature, and permit the use of the fixing device when the surface temperature of the heat roller rises by a predetermined temperature after dropping maximally.

Preferably, the image forming apparatus further comprises ambient temperature detections means, and the controller exercises the control of the fixing device when the ambient temperature, as detected by the ambient temperature detections means, is lower than a predetermined value.

### BRIEF DESCRIPTION OF THE DRAWINGS

FIG. 1 is a schematic view showing a construction of an image forming apparatus according to the present invention;

FIG. 2 is a schematic sectional view showing a construction of a fixing device provided in the image forming apparatus illustrated in FIG. 1;

FIG. 3 is a schematic view showing a control-related construction provided in the image forming apparatus illustrated in FIG. 1 for performing control of the fixing device; and

FIG. 4 is a diagrammatic view showing an embodiment of control over the fixing device exercised by a controller provided in the image forming apparatus illustrated in FIG. 1, the diagrammatic view showing the relationship between a warm-up time and the surface temperatures of a heat roller and a pressure roller.

### DETAILED DESCRIPTION OF THE PREFERRED EMBODIMENT

Embodiments of a copier, an image forming apparatus according to the present invention, will now be described in detail with reference to the accompanying drawings.

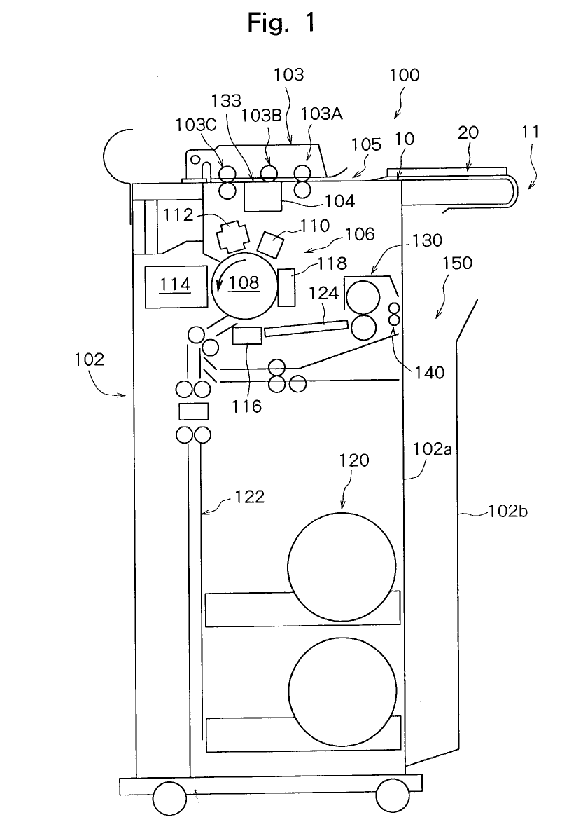

By reference to FIG. 1, a copier, entirely indicated by the numeral 100, has a nearly rectangular parallelopipedal copier body 102. A document transport path 133 is formed on the upper end surface of the copier body 102, and a document feeder 103 is provided on the document transport path 133. At an upstream end portion of the document transport path 133 (a right-hand end portion in FIG. 1), a document placing table 10 juts out from the copier body 102. At an upstream end portion of the document feeder 103, a document insertion port 105 is formed in cooperation with the document transport path 133. In the document feeder 103, a carry-in roller pair 103A, a document hold-down roller 103B, and a delivery roller pair 103C are disposed in this sequence in an upstream-downstream direction of the document transport path 133. An image pickup device, a close-contact image sensor 104 in the present embodiment, is disposed in an upper end portion within the copier body 102 and at a position directly below the document hold-down roller 103B.

Image forming means (imaging means) 106 is disposed below the close-contact image sensor 104. The image forming means 106 includes a photoconductor drum 108. The photoconductor drum 108 is rotationally driven counterclockwise in FIG. 1 by drive means (not shown). Around the photoconductor drum 108, there are disposed a main charger 110 for uniformly charging the surface of the photoconductor drum 108; a device for converting electric signals, which have been outputted by the close-contact image sensor 104 having read the image of the document (i.e., outputted after photoelectric conversion), into light and throwing the light onto the surface of the photoconductor drum 108 to form an electrostatic latent image, namely, an LED print head 112 in the embodiment; a developing device 114 for developing the electrostatic latent image formed on the surface of the photoconductor drum 108 into a toner image; a transfer device 116 for transferring the toner image formed on the surface of the photoconductor drum 108 onto a sheet such as plain paper; and a cleaning device 118 for wiping off toner remaining on the surface of the photoconductor drum 108 and recovering the toner. The photoconductor drum 108, and the main charger 110, LED print head 112, and developing device 114 disposed around the photoconductor drum 108 constitute the image forming means 106. The document placing table 10, document transport path 133, document feeder 103, and close-contact image sensor 104 constitute a document reader provided in the copier 100.

A paper accommodating portion 120 including paper feed rollers, and a paper transport path 122 for transporting the paper accommodated in the paper accommodating portion 120 to a transfer zone of the image forming means 106 are disposed at a lower position within the copier body 102. The paper transport path 122 is provided with various transport roller pairs for transporting the paper wound round the paper feed rollers in the paper accommodating portion 120 through the paper transport path 122, and a cutter for cutting the paper to a suitable length. A sheet transport path 124 for transporting the sheet having the toner image transferred thereto by the transfer device 116 is provided downstream from the transport device 116. A fixing device 130 is disposed at a downstream position of the sheet transport path 124. A transport roller pair, a delivery roller pair 140 in the embodiment, is provided downstream from the fixing device 130. A front cover 102b is disposed on a front surface 102a (right end surface in FIG. 1) of the copier body 102. A pocket 150 for accommodating sheets delivered by the delivery roller pair 140 is formed between the front cover 102b and the front surface 102a of the copier body 102.

The document inserted through the document insertion port 105 into the document feeder 103 is transported in the downstream direction by the carry-in roller pair 103A, document hold-down roller 103B and delivery roller pair 103C. The image of the document transported along the document transport path 133 is read by the close-contact image sensor 104. The image read by the close-contact image sensor 104 is converted into a toner image by the image forming means 106, and is then transferred by the transfer device 116 onto the sheet transported from the paper accommodating portion 120. The toner image transferred onto and borne by the sheet is fixed by the fixing device 130, and is delivered into the pocket 150 by the delivery roller pair 140. The sheet transported from the paper accommodating portion 120 is the paper that has been cut to a predetermined length by the cutter with a suitable timing. Generally in the manner described above, document image reading and copying actions are performed by the copier 100 having the document reader, whereby copies having records of the image of the document are produced.

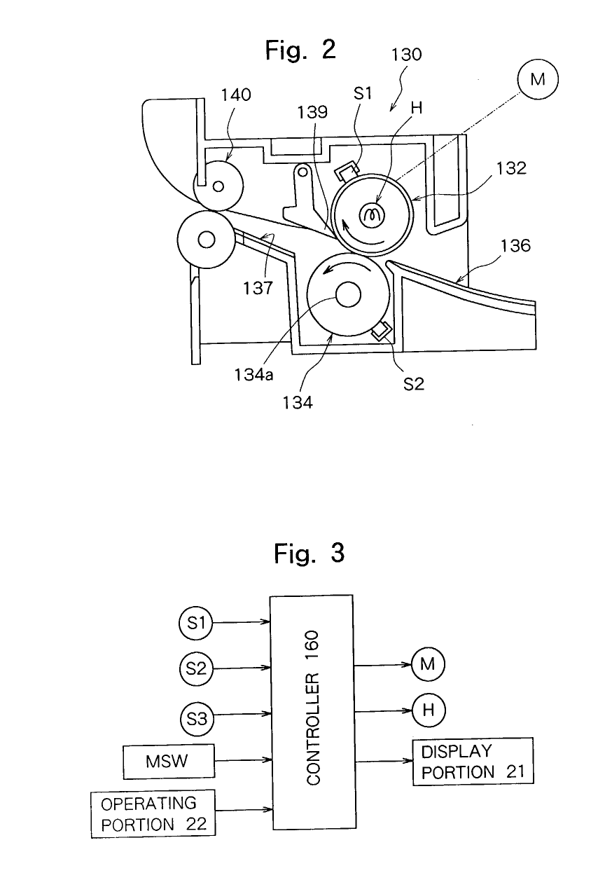

Next, the fixing device 130 will be described with reference to FIG. 2. The fixing device 130 is equipped with a heat roller 132, and a pressure roller 134 disposed below the heat roller 132 and rotatable in pressurized contact with the heat roller 132. The heat roller 132 has a structure having a coating layer of a material with satisfactory mold release characteristics, for example, PTFE, present on the surface of a hollow core of aluminum. The heat roller 132 is rotatably supported by a stationary frame of the fixing device 130 via a bearing (not shown). An inlet gear (not shown) is attached to one end of the heat roller 132, and this inlet gear is drivingly connected to an electric motor M, a drive source. In the hollow interior of the heat roller 132, a halogen lamp (H), a heater (heating means), is disposed so as to extend in an axial direction. The pressure roller 134 without the heater H has a structure comprising a layer of silicone rubber, heat resistant rubber, formed on the surface of a hollow core of aluminum, and a coating layer of Teflon (registered trademark) further provided on the surface of the silicone rubber layer, the hollow core being fixed to a shaft 134a. The pressure roller 134 has its shaft 134a rotatably supported by a bearing block (not shown), and the bearing block is supported by the stationary frame of the fixing device 130 so as to be slidable in an up-down direction. Spring means (not shown) is interposed between the bearing block and the stationary frame of the fixing device 130, and the bearing block is always urged upwardly by the spring means. Because of the construction described above, the pressure roller 134 is always brought into pressurized contact with the surface of the heat roller 132, and is thus rotated while following the rotation of the heat roller 132. In the fixing device 130, a carry-in path 136 for the sheet is disposed upstream from the heat roller 132 and the pressure roller 134, and a delivery path 137 for the sheet is disposed downstream from the heat roller 132 and the pressure roller 134. The delivery roller pair 140 is disposed at the downstream end of the delivery path 137. A peeling claw 139 is supported by the stationary frame of the fixing device 130 downstream from the heat roller 132 and the pressure roller 134. A front end portion of the peeling claw 139 is in contact with the surface of the heat roller 132.

After the power is turned on for starting the copier 100, the halogen lamp H, the heater for the heat roller 132 in the fixing device 130, is energized to start heating of the heat roller 132. The fixing device 130 is warmed up by a controller 160, as will be described in detail later. After warm-up of the fixing device 130 is completed, the sheet having the toner image transferred onto its surface by the image forming means 106 is transported to the carry-in path 136 of the fixing device 130. While the sheet bearing the toner image is passing through the nip between the heat roller 132 and the pressure roller 134, which are both rotated, with a predetermined timing, the toner image is fixed onto the surface of the sheet. The sheet having the toner image fixed thereto is transported to the delivery roller pair 140 by the heat roller 132 and the pressure roller 134 through the delivery path 137, and delivered into the pocket 150 of the copier body 102 by the delivery roller pair 140. The peeling claw 139 prevents the sheet from winding about the heat roller 132.

Heat roller surface temperature detection means for detecting the surface temperature of the heat roller 132, and pressure roller surface temperature detection means for detecting the surface temperature of the pressure roller 134 are disposed in the fixing device 130. The heat roller surface temperature detection means is composed of a temperature sensor, for example, a thermistor S1. The thermistor S1 is disposed on the stationary frame of the fixing device 130 so as to contact the surface of the heat roller 132. The pressure roller surface temperature detection means is composed of a temperature sensor, for example, a thermistor S2. The thermistor S2 is disposed on the stationary frame of the fixing device 130 so as to contact the surface of the pressure roller 134. Ambient temperature detection means for measuring the ambient temperature of a place, where the copier 100 is installed, is disposed inside of a cover (not shown) of the copier body 102. The ambient temperature detection means is composed of a suitable temperature sensor S3 which may use a construction well known per se.

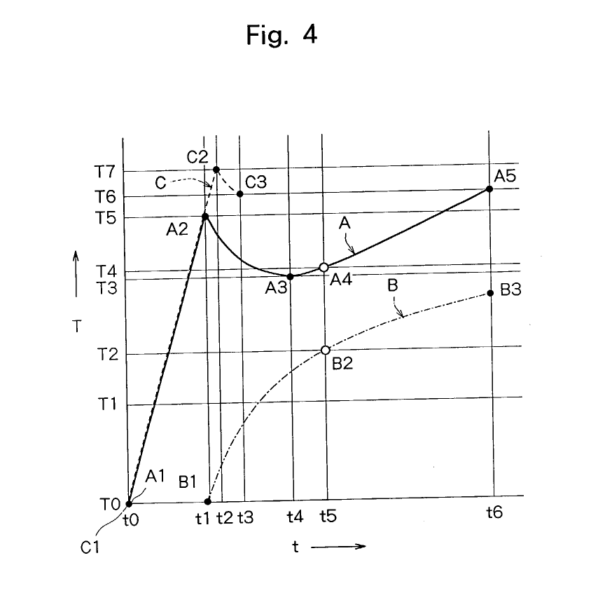

With reference to FIG. 3, the controller 160 capable of controlling the fixing device 130 is provided within the copier body 102. The controller 160, which may use a controller controlling the entire copier 100, is composed of a microcomputer. The controller 160 is equipped with a central processing unit (CPU) for performing computation in accordance with a control program, a ROM for storing the control program, a RAM for storing the results of computation, a timer, a counter, an input interface, and an output interface. The input interface of the so constituted controller 160 receives detection signals from the thermistors S1 and S2, the temperature sensor S3 for measuring the ambient temperature, a power source switch (main switch) MSW of the copier 100, and other detectors. The output interface outputs control signals to the electric motor M and the halogen lamp H which is the heater, and a display portion 21. An operating portion 22 comprises an operating panel (not shown) in which a copy start key, copy quantity keys, and various other keys (not shown) are disposed. Thus, the controller 160 also receives various pieces of information, necessary for copying, from the power source switch MSW of the copier 100, copy start key and various other keys. The display portion 21 gives various displays such as “Can copy”. The ambient temperature of the place where the copier 100 is installed, the surface temperatures of the heat roller 132 and the pressure roller 134, the set values (set temperatures) such as the fixing standby temperature, etc. are stored in the ROM beforehand.

Next, an embodiment of warm-up control of the fixing device 130 by the controller 160 will be explained. Mainly with reference to FIGS. 3 and 4, when the power source switch MSW disposed in the copier 100 is turned on, the controller 160 makes determination. If the controller 160 determines based on input signals from the temperature sensor S3 that the ambient temperature is not lower than a predetermined ambient temperature, for example, 18° C., the controller 160 sets warm-up control of the fixing device 130 in an ordinary temperature atmosphere mode. If the controller 160 determines that the ambient temperature is lower than the predetermined ambient temperature of 18° C., the controller 160 sets warm-up control of the fixing device 130 in a low temperature atmosphere mode. In accordance with either set mode, the controller 160 performs warm-up control. When the low temperature atmosphere mode has been set, the controller 160 exercises warm-up control over the fixing device 130 in accordance with the present invention. Thus, the warm-up control when the low temperature atmosphere mode has been set will be described first. In the grammatical view shown in FIG. 4, the vertical axis represents the detected surface temperature T (e.g. ° C.) of each of the heat roller 132 and the pressure roller 134, while the horizontal axis represents the elapsed time t (e.g. seconds) since heating of the heat roller 132 is started upon energization of the halogen lamp H. A solid line A is a grammatical representation of changes in the detected heat roller surface temperature. A one-dot chain line B is a grammatical representation of changes in the detected pressure roller surface temperature. Both of these lines are the grammatical representations in the warm-up control when the low temperature atmosphere mode has been set. A dashed line C is a grammatical representation of changes in the detected heat roller surface temperature in the warm-up control when the ordinary temperature atmosphere mode has been set.

Assume here that, as stated earlier, after power-on of the power source switch MSW, the controller 160 determines based on input signals from the temperature sensor S3 that the ambient temperature is lower than the predetermined ambient temperature of 18° C. In this case, the controller sets the warm-up control of the fixing device 130 in the low temperature atmosphere mode. Then, the controller 160, while keeping the heat roller 132 and the pressure roller 134 at a standstill, outputs control signals to switch means of the drive circuit, including the halogen lamp H, connected to the power source, thereby supplying an electric power to the halogen lamp H. Heating of the heat roller 132 is started thereby. Simultaneously, the controller 160 checks the surface temperature of the heat roller 132 based on input signals from the thermistor S1.

The controller 160 exercises control such that until the surface temperature of the heat roller 132 detected by the thermistor S1 reaches a first set heat roller surface temperature T5, i.e., a set temperature (set value) which is lower than a fixing standby temperature T6, the electric motor M is not driven, and the heat roller 132 and the pressure roller 134 are both kept at a standstill. The first set heat roller surface temperature T5 is preferably a temperature necessary to soften toner remaining between the surface of the heat roller 132 and the peeling claw 139 in order to prevent the surface of the heat roller 132 from being damaged because of the remaining toner while the heat roller 132 is rotating. The surface temperature of the heat roller 132 is sharply raised (see the solid line A going from a point A1 to a point A2 in FIG. 4). The pressure roller 134 is locally heated by the heat roller 132 in the nip region between the pressure roller 134 and the heat roller 132. Thus, rises in the surface temperature of the pressure roller 134 in other regions are substantially zero.

When the surface temperature of the heat roller 132 rises from T0 (the temperature corresponding to the ambient temperature) and reaches the first set heat roller surface temperature T5 (the surface temperature of the heat roller 132 starts from the point A1 (time t0) to the point A2 (time t1) in the solid line A) in FIG. 4, the controller 160 outputs control signals to the electric motor M to drive the electric motor M rotationally. The heat roller 132 and the pressure roller 134 are both rotationally driven, and their respective rotations are started. The controller 160 also checks the surface temperature of the pressure roller 134 based on input signals from the thermistor S2. In the present embodiment, the controller 160 continues the rotational driving of the heat roller 132 and the pressure roller 134 until the surface temperature of the heat roller 132 detected by the thermistor S1 reaches the fixing standby temperature T6.

Since the heat roller 132 and the pressure roller 134 are both rotationally driven, the surface temperature of the heat roller 132 begins to lower from the first set heat roller surface temperature T5, and maximally drops to a surface temperature T3. Then, the surface temperature of the heat roller 132 continues to rise relatively gently, reaching the fixing standby temperature T6 (see the solid line A starting at the point A2 (time t1), passing a point A3 (time T4) and a point A4 (time T5), and arriving at a point A5 (time T6) in FIG. 4). On the other hand, the surface temperature of the pressure roller 134 is raised relatively sharply, and then continues a relatively mild rise. At a time when the surface temperature of the heat roller 132 reaches the fixing standby temperature T6, the surface temperature of the pressure roller 134 reaches a considerably lower temperature than the fixing standby temperature T6 (see the one-dot chain line B starting at a point B1 (time t1), passing a point B2 (time T5), and arriving at a point B3 (time T6) in FIG. 4). In FIG. 4, T2 is the surface temperature of the pressure roller 134 (the set pressure roller surface temperature, the predetermined value) reached at a time when the surface temperature of the heat roller 132, after maximally dropping from T5 to T3 (point A3), rises by a predetermined temperature (a value obtained by subtracting T3 from T4) to reach a second set heat roller surface temperature T4 [point A4 (time T5) in FIG. 4].

In one embodiment, the controller 160, as described earlier, controls the fixing device 130 so as to permit the use of the fixing device 130 at a time when the surface temperature of the pressure roller 134 detected by the thermistor S2 reaches the predetermined value T2 (point B2 (time T5) in FIG. 4) in a state in which the heat roller 132 and the pressure roller 134 are both rotationally driven. The set pressure roller surface temperature T2, the predetermined value of the surface temperature of the pressure roller 134, can be set, at least, as a temperature at which a minimally sufficient fixing effect for practical use can be obtained. The controller 160 outputs signals for enabling the start of use of the fixing device 130 at a point of time at which the surface temperature of the pressure roller 134 reaches the predetermined value T2 [point B2 (time T5) in FIG. 4]. At this point of time (the elapsed time T5), the display “Can copy”, which shows a possibility for copying, is made in the display portion 21. If the copy start key has already been pressed, or if the copy start key is pressed after this point of time, the controller 160 permits the start of use of the fixing device 130, accordingly the start of the copy action of the copier 100, even before the surface temperature of the heat roller 132 reaches the fixing standby temperature T6. Thus, the copier 100 starts a copy action, and a fixing action by the fixing device 130 is performed.

If the copy start key is not on at this point of time, the controller 160 continues the rotations of the heat roller 132 and the pressure roller 134 until the surface temperature of the heat roller 132 reaches the fixing standby temperature T6, as stated already. When the surface temperature of the heat roller 132 reaches the fixing standby temperature T6 (when it is raised from the point A4 to the point A5 in the solid line A in FIG. 4), the controller 160 outputs control signals to the electric motor M to stop the rotational driving of the electric motor M. As a result, the heat roller 132 and the pressure roller 134 are both caused to stop rotating. During this period, the surface temperature of the pressure roller 134 is raised from the point B2 to the point B3 in the solid line B in FIG. 4.

As will be easily understood from the foregoing descriptions and FIG. 4, the controller 160 initially starts the heating of the heat roller 132 by the halogen lamp H in a state in which the heat roller 132 and the pressure roller 134 are at a stop. Thus, the surface temperature of the heat roller 132 is sharply raised to the first set heat roller surface temperature T5, the aforementioned set value, in a relatively short time (see the solid line from the point A1 to the point A2 in FIG. 4). After the surface temperature of the heat roller 132 reaches the set value T5 and the rotations of the heat roller 132 and the pressure roller 134 are started, the surface temperature of the pressure roller 134 is raised uniformly and relatively gently. Whereas the surface temperature of the heat roller 132 is once dropped (see the solid line from the point A2 to the point A3 to close to the point A4 in FIG. 4), since the amount of heat of the heat roller 132 is greatly deprived by the pressure roller 134. In this state, the conventional copier operates in the following manner: The rotational driving of the rollers 132 and 134 is carried out until the surface temperature of the heat roller 132 reaches the fixing standby temperature T6. Only thereafter, the start of use of the fixing device 130, accordingly the start of the copy action of the copier 100, becomes possible. In the conventional copier, therefore, the period from energization of the halogen lamp H until the use of the fixing device 130, accordingly the copy action of the copier 100, can be started is required to last for the time T6. This means a particularly long warm-up time in the low temperature atmosphere.

According to the above-described copier 100 of the present invention, on the other hand, the controller 160 starts the heating of the heat roller 132 in a state in which the heat roller 132 and the pressure roller 134 are at a stop. Then, the controller 160 controls the fixing device 130 so as to start the rotations of the heat roller 132 and the pressure roller 134 at a time when the surface temperature of the heat roller 132 detected by the thermistor S1 reaches the set value T5 which is lower than the fixing standby temperature T6, and so as to permit the use of the fixing device 130 at a time when the surface temperature of the pressure roller 134 detected by the thermistor S2 reaches the predetermined value T2. Hence, compared with the conventional copier discussed above, the image forming apparatus of the present invention enables the start of use of the fixing device 130, accordingly the start of the copy action of the copier 100, in the warm-up time T5, which is shorter than the conventional warm-up time T6, in a low temperature atmosphere without impairing the desired fixing effect. At this point in time, the surface temperature of the heat roller 132 detected by the thermistor S1 has not reached the fixing standby temperature T6, but is the second set heat roller surface temperature T4 (point A4 in FIG. 4) which is lower than the fixing standby temperature T6 (also lower than the first set heat roller surface temperature T5, the set value, in the present embodiment). Nevertheless, the desired fixing effect is not impaired. The reason for this has been confirmed by experiments conducted by the present inventors, which demonstrate that if the surface temperature of the pressure roller 134 reaches the predetermined value T2, a fixing effect minimally sufficient for practical use is obtained even in a low temperature atmosphere. It goes without saying that the predetermined value T2, the surface temperature of the pressure roller 134, is practically set, as desired, according to the type of the copier.

In other embodiment, the controller 160, as described earlier, controls the fixing device 130 so as to permit the use of the fixing device 130 at a time when the surface temperature of the heat roller 132 detected by the thermistor S1, after maximally dropping to T3, rises by a predetermined temperature (a value obtained by subtracting T3 from T4) to reach the second set heat roller surface temperature T4 [point A4 (time T5) in FIG. 4], in a state in which the heat roller 132 and the pressure roller 134 are both rotationally driven. At this time, it is important that the surface temperature of the pressure roller 134, at least, reaches the predetermined value T2, the temperature for obtaining a fixing effect minimally sufficient for practical use, in a low temperature atmosphere. In other words, the second set heat roller surface temperature T4 (point A4), which permits the use of the fixing device 130 and which is reached when the surface temperature of the heat roller 132 rises by the predetermined temperature (the value obtained by subtracting T3 from T4), is set on condition that the surface temperature of the pressure roller 134, at least, is not lower than the predetermined value T2, the temperature for obtaining a fixing effect minimally sufficient for practical use, in a low temperature atmosphere.

The controller 160, as described earlier, outputs signals for allowing the start of use of the fixing device 130 at a time when the surface temperature of the heat roller 132, after maximally dropping to T3, rises by the predetermined temperature to reach the second set heat roller surface temperature T4. At this point of time (the elapsed time T5), the display “Can copy”, which shows a possibility for copying, is made in the display portion 21. If the copy start key has already been pressed, or if the copy start key is pressed after this point of time, the controller 160 permits the start of use of the fixing device 130, accordingly the start of the copy action of the copier 100, even before the surface temperature of the heat roller 132 reaches the fixing standby temperature T6. Thus, the copier 100 starts a copy action, and a fixing action by the fixing device 130 is performed.

If the copy start key is not on at this point of time, the controller 160 continues the rotations of the heat roller 132 and the pressure roller 134 until the surface temperature of the heat roller 132 reaches the fixing standby temperature T6, as stated already. When the surface temperature of the heat roller 132 reaches the fixing standby temperature T6 (when it is raised from the point A4 to the point A5 in the solid line A in FIG. 4), the controller 160 outputs control signals to the electric motor M to stop the rotational driving of the electric motor M. As a result, the heat roller 132 and the pressure roller 134 are both caused to stop rotating. During this period, the surface temperature of the pressure roller 134 is raised from the point B2 to the point B3 in the solid line B in FIG. 4.

In the other embodiment above, the controller 160, as described earlier, controls the fixing device 130 so as to permit the use of the fixing device 130 at a time when the surface temperature of the heat roller 132 detected by the thermistor S1, after maximally dropping to T3, rises by the predetermined temperature (the value obtained by subtracting T3 from T4) to reach the second set heat roller surface temperature T4 [i.e. point A4 (time T5) in FIG. 4], in a state in which the heat roller 132 and the pressure roller 134 are both rotationally driven. Hence, compared with the conventional copier discussed above, the image forming apparatus of the present invention enables the start of use of the fixing device 130, accordingly the start of the copy action of the copier 100, in the warm-up time T5, which is shorter than the conventional warm-up time T6, in a low temperature atmosphere without impairing the desired fixing effect.

Next, warm-up control when setting the ordinary temperature atmosphere mode in the fixing device 130 will be explained. As stated earlier, when the power source switch MSW is turned on, the controller 160 makes determination. If the controller 160 determines based on input signals from the temperature sensor S3 that the ambient temperature is not lower than the predetermined ambient temperature of 18° C., the controller 160 sets warm-up control of the fixing device 130 in the ordinary temperature atmosphere mode. Then, the controller 160, while keeping the heat roller 132 and the pressure roller 134 at a standstill, outputs control signals to switch means of the drive circuit, including the halogen lamp H, connected to the power source, thereby supplying an electric power to the halogen lamp H. Heating of the heat roller 132 is started thereby. Simultaneously, the controller 160 checks the surface temperature of the heat roller 132 based on input signals from the thermistor S1.

The controller 160 exercises control such that until the surface temperature of the heat roller 132 detected by the thermistor S1 reaches a first set heat roller surface temperature T7, which is higher than the fixing standby temperature T6, the electric motor M is not driven, and the heat roller 132 and the pressure roller 134 are both kept at a standstill. The surface temperature of the heat roller 132 is sharply raised (see the dashed line C going from a point C1 to a point C2 in FIG. 4). The pressure roller 134 is locally heated by the heat roller 132 in the nip region between the pressure roller 134 and the heat roller 132. Thus, rises in the surface temperature of the pressure roller 134 in other regions are substantially zero.

When the surface temperature of the heat roller 132 rises and reaches the first set heat roller surface temperature T7 (starts from the point C1 and reaches the point C2 in the dashed line C in FIG. 4) in the ordinary temperature atmosphere mode, the controller 160 outputs control signals to the electric motor M to drive the electric motor M rotationally. The heat roller 132 and the pressure roller 134 both start to be rotated. In FIG. 4, t2 refers to a period of time from the energization of the halogen lamp H until the time when the surface temperature of the heat roller 132 reaches the first set heat roller surface temperature T7 in the ordinary temperature atmosphere mode (the period of time until the surface temperature of the heat roller 132 starts at the point C1 and reaches the point C2 in the dashed line C in FIG. 4). Since the heat roller 132 and the pressure roller 134 are both rotationally driven, the surface temperature of the heat roller 132 begins to lower from the first set heat roller surface temperature T7 in the ordinary temperature atmosphere mode (see the dashed line C going from the point C2 to point C3 in FIG. 4), while the surface temperature of the pressure roller 134 is raised (not shown). The rotational driving of the heat roller 132 and the pressure roller 134 is continued until the surface temperature of the heat roller 132 falls to the fixing standby temperature T6.

If the controller 160 determines that the surface temperature of the heat roller 132 reaches the fixing standby temperature T6 (falls from the point C2 to the point C3 in the dashed line C in FIG. 4), the controller 160 outputs control signals to the electric motor M to stop the rotational driving of the electric motor M. Simultaneously, the controller 160 outputs signals enabling the start of use of the fixing device 130, accordingly the start of the copy action of the copier 100. In FIG. 4, t3 refers to a period of time from the energization of the halogen lamp H until the time when the surface temperature of the heat roller 132 reaches the first set heat roller surface temperature T7 and further falls to the fixing standby temperature T6 (the period of time until the surface temperature of the heat roller 132 starts at the point C1, passes the point C2, and reaches the point C3 in the dashed line C in FIG. 4). It goes without saying that the time t3, accordingly the warm-up time in the ordinary temperature atmosphere, is shorter than the time T5 in the low temperature atmosphere, accordingly the warm-up time in the low temperature atmosphere. The above-described warm-up control in the ordinary temperature atmosphere is conventional warm-up control, and does not constitute the characteristics of the present invention. Incidentally, control after the surface temperature of the heat roller 132 reaches the fixing standby temperature T6 (point C3 in FIG. 4) may itself be conventional control, and does not constitute the characteristic of the present invention. Thus, a description of such control is omitted herein.

The image forming apparatus according to the present invention has been described above based on the embodiments. However, this invention is not restricted to the illustrated embodiments, but may be variously modified and changed without departing from the scope of the technical ideas of the invention. For example, there may be another embodiment in which while the rotational driving of the heat roller 132 and the pressure roller 134 is continuing, signals for permitting the start of use of the fixing device 130, accordingly the start of the copy action of the copier 100, are outputted in the aforementioned manner, whereafter, if no copy start signal is inputted, the rotational driving of the heat roller 132 and the pressure roller 134 is stopped. In this case, energization of the halogen lamp H is continued until the surface temperature of the heat roller 132 reaches the fixing standby temperature T6. Furthermore, there may be another embodiment in which after the controller 160 starts the heating of the heat roller 132 while stopping the heat roller 132 and the pressure roller 134, the controller 160 controls the fixing device 130 so as to start the rotations of the heat roller 132 and the pressure roller 134 at a time when the surface temperature of the heat roller 132 detected by the thermistor S1 reaches the set value (the first set heat roller surface temperature) T5 which is lower than the fixing standby temperature T6, and so as to permit the use of the fixing device 130 at a time when the surface temperature of the pressure roller 134 detected by the thermistor S2 reaches the predetermined value T2, and at a time when the surface temperature of the heat roller 132, after maximally dropping, rises by the predetermined temperature, or at a time when the surface temperature of the heat roller 132, after maximally dropping, reaches the second set value (the second set heat roller surface temperature) T4.

The present invention is applied to the fixing device 130 having the heat roller 132 incorporating the halogen lamp H, and the pressure roller 134 rotating in pressurized contact with the heat roller 132. However, the construction of the fixing device 130 is not limited to the above construction, but can be applied in cases in which the heat roller 132 is itself a heating element using, for example, a ceramic heater.

What we claim is:

1. An image forming apparatus which passes a sheet bearing a toner image between a heat roller and a pressure roller constituting a fixing device to fix the toner image onto the sheet, comprising
heat roller surface temperature detection means, pressure roller surface temperature detection means, and a controller for controlling the fixing device, and wherein
the controller controls the fixing device so as to start heating of the heat roller while stopping the heat roller and the pressure roller, then start rotations of both the heat roller and the pressure roller when a surface temperature of the heat roller, as detected by the heat roller surface temperature detection means, reaches a set value which is lower than a fixing standby temperature, and permit use of the fixing device when a surface temperature of the pressure roller, as detected by the pressure roller surface temperature detection means, reaches a predetermined value.

2. An image forming apparatus which passes a sheet bearing a toner image between a heat roller and a pressure roller constituting a fixing device to fix the toner image onto the sheet, comprising
heat roller surface temperature detection means, pressure roller surface temperature detection means, and a controller for controlling the fixing device, and wherein
the controller controls the fixing device so as to start heating of the heat roller while stopping the heat roller and the pressure roller, then start rotations of both the heat roller and the pressure roller when a surface temperature of the heat roller, as detected by the heat roller surface temperature detection means, reaches a set value which is lower than a fixing standby temperature, and permit use of the fixing device when a surface temperature of the heat roller rises by a predetermined temperature after dropping maximally.

3. The image forming apparatus of claim 1, further comprising ambient temperature detections means, and wherein the controller exercises the control of the fixing device when an ambient temperature, as detected by the ambient temperature detections means, is lower than a predetermined value.
